(19) United States
(12) Patent Application Publication
(10) Pub. No.: US 2009/0195491 A1
(43) Pub. Date: Aug. 6, 2009

(54) Multi-domain display device

(75) Inventor: Naoki Hayashi, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/289,697

(22) Filed: Oct. 31, 2008

(30) Foreign Application Priority Data
Feb. 1, 2008 (JP) 2008-22452

(51) Int. Cl. G09G 3/36; G02F 1/1333

(52) U.S. Cl. 345/94; 349/144

(57) ABSTRACT

There is a problem inherent in a multi-domain display device having a configuration in which a plurality of domains are formed in one pixel or one sub-pixel, in that a resolving power beyond the size of a unit pixel or a unit sub-pixel cannot be obtained. Provided is a multi-domain display device, including: a display element including a unit pixel or a unit sub-pixel divided into a plurality of domains; and a mode switching circuit for switching, in response to a mode control signal, a mode in which the plurality of domains are collectively driven to enable a high-viewing-angle image display, and a mode in which the plurality of domains are independently driven to enable a high-resolving-power image display.

### BACKGROUND OF THE INVENTION

1. Field of the Invention

The present invention relates to a multi-domain display device.

2. Description of the Related Art

A multi-domain has a configuration in which a plurality of domains are formed in one pixel or one sub-pixel. The multi-domain technology disclosed in JP 07-191323 A is an orientation dividing technology of, in order to compensate for viewing-angle dependence in a transmissive liquid crystal display element, providing the respective domains with different orientations (characteristics relating to orientation direction of liquid crystal molecules).

However, with the above-mentioned conventional technology, a resolving power beyond the size of a unit pixel or a unit sub-pixel cannot be obtained.

A general display device for an office personal computer or a television receiver (exclusively for displaying images of natural landscape), which displays an electronic program guide, mainly displays characters, that is, high-density lines. Accordingly, as specifications required by a viewer for those display device and receiver, a high resolving power is required to suppress shaggy conspicuous in outlines.

Then, in order to display a character, a line, or the like formed of image signals having relatively higher resolution compared with the image signals of natural landscape, there is desired a multi-domain display device having a high resolving power.

### SUMMARY

In order to solve the above-mentioned problem, a device in a liquid crystal display according to the present invention includes: a pixel divided into at least two sub-pixels, the at least two sub-pixels having characteristics of color channels different from each other, each of the at least two sub-pixels being divided into at least two domains, the at least two domains having characteristics of viewing-angles different from each other; a first terminal coupled to one of the at least two domains to display image; and a second terminal coupled to another of the at least two domains to display image.

According to the present invention, there can be provided a multi-domain display device having a high resolving power.

### BRIEF DESCRIPTION OF THE DRAWINGS

In the accompanying drawings:

FIG. 1 is a block diagram of a multi-domain display device according to a first embodiment of the present invention;

FIG. 2 is a block diagram of a multi-domain display device according to a second embodiment of the present invention;

FIG. 3 is a block diagram of a multi-domain display device according to a third embodiment of the present invention;

FIG. 4 is a system diagram of a multi-domain display device according to a fourth embodiment of the present invention;

FIG. 5 is a system diagram of a multi-domain display device according to a fifth embodiment of the present invention;

FIG. 6 is a timing chart showing operation of the multi-domain display device according to the fifth embodiment of the present invention;

FIG. 7 is another timing chart showing the operation of the multi-domain display device according to the fifth embodiment of the present invention; and

FIG. 8 is still another timing chart showing the operation of the multi-domain display device according to the fifth embodiment of the present invention.

### DETAILED DESCRIPTION OF THE PREFERRED EMBODIMENTS

Hereinafter, specific embodiments to which the present invention is applied are described in detail with reference to the drawings. The same components are denoted by the same symbols in the respective drawings, and an overlapping explanation is omitted as necessary for simplicity of explanation.

### First Embodiment

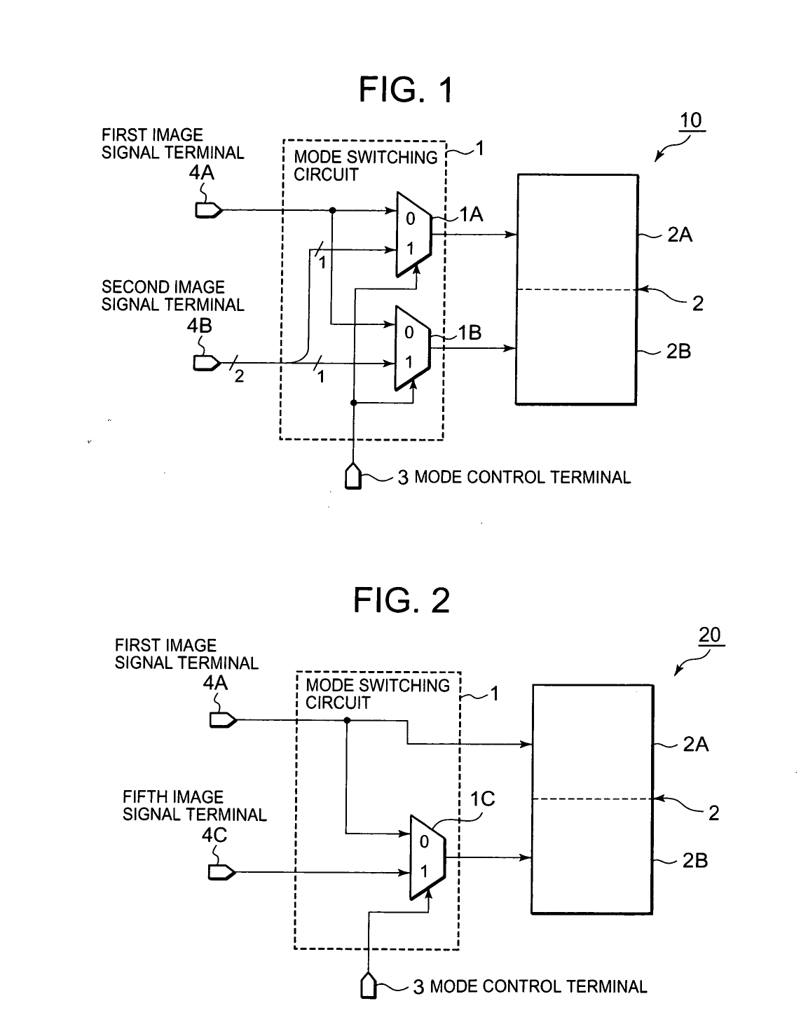

FIG. 1 is a block diagram showing a configuration of a multi-domain display device according to a first embodiment of the present invention. Reference numeral 10 denotes the multi-domain display device, which is configured in accordance with the most fundamental requirement based on the present invention.

Reference numeral 2 denotes one pixel or one sub-pixel. Reference symbol 2A and reference symbol 2B each denote domains formed in one pixel or one sub-pixel. In this embodiment, a configuration including two domains is illustrated, but the present invention is not limited thereto and may have a configuration in which one pixel or one sub-pixel is divided into two or more domains.

Reference numeral 1 denotes a mode switching circuit, which includes selecting circuits denoted by reference symbols 1A and 1B. Based on signals output by the selecting circuits 1A and 1B, the domains 2A and 2B are driven, respectively.

Reference symbols 4A and 4B denote a first image signal and a terminal receiving input thereof, and a second image signal and a terminal receiving input thereof, respectively. The first image signal terminal 4A represents one terminal, whereas the second image signal terminal 4B represents a bunch of two combined terminals. That is, the second image signal terminal 4B can simultaneously receive input of the larger number of signals compared with the first image signal terminal 4A, and thus is capable of receiving input of a higher-resolution image signal.

Then, one signal input to the second image signal terminal 4B is input to the selecting circuit 1A, and another signal is input to the selecting circuit 1B. Note that one signal input to the first image signal terminal 4A is input to the selecting circuits 1A and 1B in common.

Reference numeral 3 denotes a mode control terminal, which represents a terminal receiving input of a signal for switching between a mode in which the domains 2A and 2B are driven collectively (hereinafter, abbreviated as collective mode) and a mode in which the domains 2A and 2B are driven independently (hereinafter, abbreviated as independent mode).

In a case of inputting a “0 (low)” signal to the mode control terminal 3, the mode switching circuit 1 goes into the collective mode, and in response to a signal input to the first image signal terminal 4A, the domains 2A and 2B are driven together by the same signal through the selecting circuits 1A and 1B.

Accordingly, the domains 2A and 2B show the same image in the collective mode, but viewing-angle dependence can be compensated by applying a transmissive crystal liquid display element to make orientations of liquid crystals of the both domains 2A and 2B different from each other. Note that, alternatively, the viewing-angle dependence can be compensated by applying a reflective liquid crystal display element to make the reflective properties of the liquid crystals of the both domains different from each other.

In a description of the first embodiment, as a display element which can be applied to the both domains in the collective mode, the transmissive liquid crystal and the reflective liquid crystal are illustrated. However, the display element is not limited thereto, and there can also be applied a generalized multi-domain technology of providing display properties different from each other to a plurality of domains which are divided to improve the display properties of a pixel unit or a sub-pixel unit.

On the other hand, in a case of putting a “1 (high)” signal to the mode control terminal 3, the mode switching circuit 1 goes into the independent mode, the domain 2A is driven through the selecting circuit 1A in response to one signal input to the second image signal terminal 4B, and the domain 2B is driven through the selecting circuit 1B in response to another signal input to the second image signal terminal 4B.

Accordingly, the domains 2A and 2B can show images different from each other in the independent mode. That is, one pixel or one sub-pixel can display an image having double the resolving power and double the resolution of the collective mode.

In one pixel or one sub-pixel shown in FIG. 1, the multi-domain is divided in a vertical direction, which is effectively applied to display of characters which have many lines in a lateral direction, such as Chinese characters.

To sum up, the collective mode can be regarded as a mode for displaying an image having a high viewing-angle, and the independent mode can be regarded as a mode for displaying an image having a high resolution. Note that a viewer watching a screen on which a character is displayed tends to gaze at the screen from the front, and demands the high resolution compared with the high viewing-angle. On the other hand, an image displaying a natural landscape is viewed mainly by a large number of viewers, who tend to be located over a wide angle with respect to the screen, and demand the high viewing-angle compared with the high resolution.

In the description of the first embodiment described above, for simplicity of description, one pixel or one sub-pixel is denoted by reference numeral 2, but an adverb “at least” should be always added thereto.

For example, in a configuration in which three sub-pixels each corresponding to red (R), green (G), and blue (B) constituting three primary colors are adjacent to each other in a lateral direction and each of the three sub-pixels is divided into two domains in a vertical direction, three domains adjacent to each other on an upper side of the vertical direction may be driven in common in response to a signal output from the selecting circuit 1, and the three domains adjacent to each other on a lower side of the vertical direction may be driven in common in response to a signal output from the selecting circuit 2.

Note that, further, in a configuration in which a plurality of pixels are adjacent to each other in the lateral direction and each of the plurality of pixels is divided into two domains in the vertical direction, a plurality of domains adjacent to each other on an upper side of the vertical direction may be driven in common in response to the signal output from the selecting circuit 1, and a plurality of domains adjacent to each other on a lower side of the vertical direction may be driven in common in response to the signal output from the selecting circuit 2.

### Second Embodiment

FIG. 2 is another block diagram showing a configuration of a multi-domain display device according to a second embodiment of the present invention. In FIG. 2, the same components as those shown in FIG. 1 are denoted by the same reference symbols. Reference numeral 20 denotes the multi-domain display device, which is configured in accordance with the most fundamental requirement based on the present invention.

Reference numeral 1 denotes a mode switching circuit, which includes a selecting circuit 1C. Reference symbol 4C denotes a terminal receiving input of a fifth image signal. In this case, the fifth image signal terminal 4C represents one terminal.

The domain 2A is driven based on a signal input to the first image terminal signal 4A, and the domain 2B is driven based on a signal output from the selecting circuit 1C. Note that the signals input to the first image signal terminal 4A and the fifth image signal terminal 4C are input to the selecting circuit 1C.

In a case where a “0” signal is input to the mode control terminal 3, the mode switching circuit 1 goes into the collective mode, and in accordance with a signal input to the first image signal terminal 4A, the domains 2A and 2B are driven together in response to the same signal.

On the other hand, in a case where a “1” signal is input to the mode control terminal 3, the mode switching circuit 1 goes into the independent mode, and in response to the signal input to the fifth image signal terminal 4C, the domain 2B is driven through the selecting circuit 1C.

Note that, in the second embodiment, the domains 2A and 2B are driven not in response to the signal input to the mode control terminal 3, but in response, to the signal input to the first image signal terminal 4A. An image signal having a higher resolution can be input to the mode switching circuit 1 in the independent mode by the both terminals of the first image signal terminal 4A and the fifth image signal terminal 4C. In other words, the image signal terminal can be reduced by one in the second embodiment compared with the first embodiment described above.

### Third Embodiment

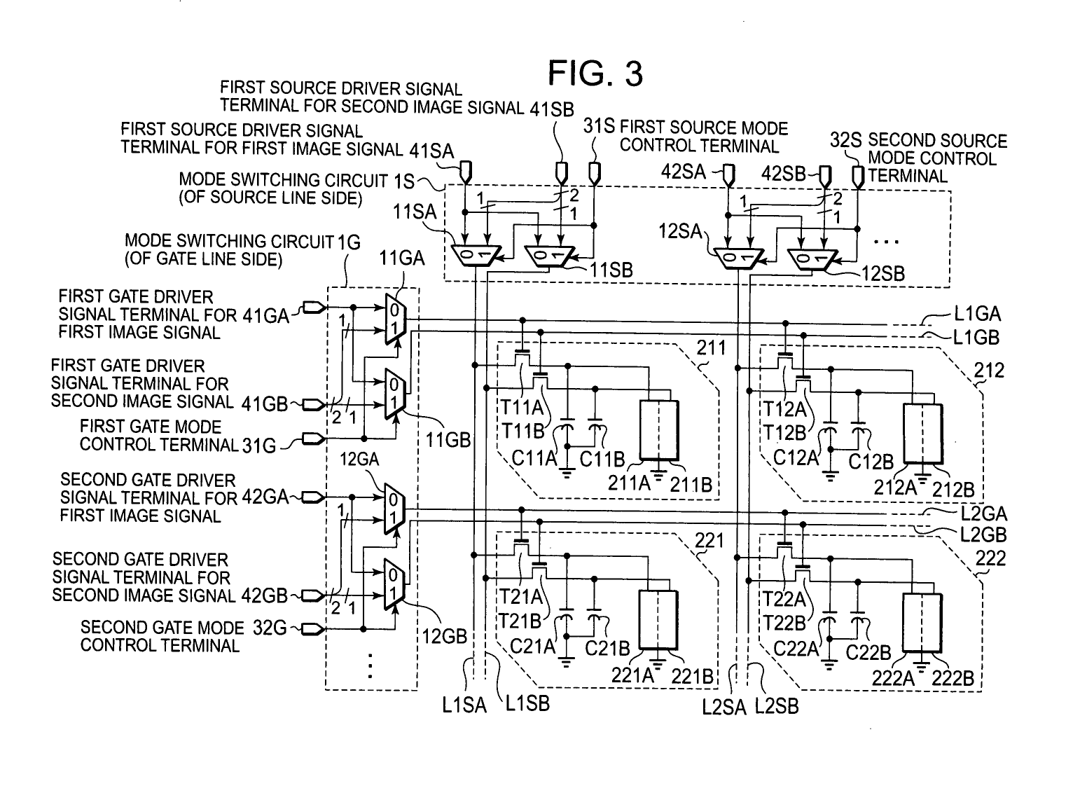

FIG. 3 is a still another block diagram showing a configuration of a multi-domain display device according to a third embodiment of the present invention. Reference numeral 30 denotes the multi-domain display device, which is configured in accordance with the most fundamental requirement based on the present invention. In particular, FIG. 3 is a block diagram emphasizing an actual display panel in which pixels or sub-pixels are arranged in matrix.

Reference numerals 211, 212, 221, and 222 each denote one pixel or one sub-pixel. Reference symbol 211A and reference symbol 211B each denote two domains formed in one pixel or one sub-pixel.

Similarly, a combination of reference symbol 212A and reference symbol 212B, a combination of reference symbol 221A and reference symbol 221B, and a combination of reference symbol 222A and reference symbol 222B correspond to a combination in which the pixel 212 is divided into domains, a combination in which the pixel 221 is divided into domains, and a combination in which the pixel 222 is divided into domains, respectively. Note that, in this embodiment, a configuration including two domains is illustrated, but the present invention is not limited thereto, and may have a configuration in which one pixel is divided into two or more domains.

Reference symbols T11A, T12A, T21A, T22A, T11B, T12B, T21B, and T22B denote thin film transistors (TFTs), which are in an OFF state when a signal applied to a gate terminal is “0” and in an ON state when the signal input to the gate terminal is “1”. Reference symbols C11A, C12A, C21A, C22A, C11B, C12B, C21B, and C22B denote auxiliary capacitors, which are connected to drain terminals of the thin film transistors T11A, T12A, T21A, T22A, T11B, T12B, T21B, and T22B, respectively.

In this case, the pixels 211, 212, 221, and 222 have the same configuration, and the configuration of the pixel 211 is described as an example. The thin film transistors T11A and T11B drive the domains 211A and 211B based on signals input to the source terminals thereof in the ON state, respectively, and drive the domains 211A and 211B based on charging potentials (potentials exhibited on the relevant drain terminals immediately before becoming the OFF state) of the auxiliary capacitors C11A and C11B in the OFF state, respectively.

Reference symbols L1GA, L1GB, L2GA, and L2GB denote gate lines, and the gate line L1GA drives gate terminals of the thin film transistors T11A and T12A in common, and the gate line L1GB drives gate terminals of the thin film transistors T11B and T12B in common. Similarly, the gate line L2GA drives gate terminals of the thin film transistors T21A and T22A in common, and the gate line L2GB drives gate terminals of the thin film transistors T21B and T22B in common.

Reference symbols L1SA, L1SB, L2SA, and L2SB denote source lines, and the source line L1SA drives source terminals of the thin film transistors T11A and T21A in common, and the source line L1SB drives source terminals of the thin film transistors T11B and T21B in common. Similarly, the source line L2SA drives source terminals of the thin film transistors T12A and T22A in common, and the source line L2SB drives source terminals of the thin film transistors T12B and T22B in common.

With a connection configuration described above, the pixels 211, 212, 221, and 222 are arranged in matrix of two rows and two columns as shown in FIG. 3, to thereby form the display device. Note that the configuration of two rows and two columns is illustrated in this embodiment, but the present invention is not limited thereto and may have an extended configuration of n-rows and m-columns (in this case, m and n represent natural numbers).

Those four gate lines, that is, the gate lines L1GA, L1GB, L2GA, and L2GB are activated in the stated order, thereby completing one screen in matrix of two rows and two columns.

When the gate line L1GA is activated, the domains 211A and 212A are driven through the source lines L1SA and L2SA, respectively. Similarly, when the gate line L1GB is activated, the domains 211B and 212B are driven through the source lines L1SB and L2SB, respectively: when the gate line L2GA is activated, the domains 221A and 222A are driven through the source lines L1SA and L2SA, respectively: and when the gate line L2GB is activated, the domains 221B and 222B are driven through the source lines L1SB and L2SB, respectively. The source line serves as a signal line, and in particular, the gate line serves as a scanning line, whereby a series of operation described above is called line-by-line scanning.

Reference symbol 1G denotes a gate-line-side mode switching circuit, which includes selecting circuits denoted by reference symbols 11GA, 11GB, 12GA, and 12GB. The gate-line-side mode switching circuit 1G drives the gate lines L1GA, L1GB, L2GA, and L2GB based on signals output from the selecting circuits 11GA, 11GB, 12GA, and 12GB, respectively.

Reference symbol 1S denotes a source-line-side mode switching circuit, which includes selecting circuits denoted by reference symbols 11SA, 11SB, 12SA, and 12SB. The source-line-side mode switching circuit 1S drives the source lines L1SA, L1SB, L2SA, and L2SB based on signals output from the selecting circuits 11SA, 11SB, 12SA, and 12SB, respectively.

In this case, a configuration in which the gate lines L1GA and L1GB are driven by the selecting circuits 11GA and 11GB is equal to a configuration in which the gate lines L2GA and L2GB are driven by the selecting circuits 12GA and 12GB, and is further equal to a configuration in which the source lines L1SA and L1SB are driven by the selecting circuits 11SA and 11SB and a configuration in which the source lines L2SA and L2SB are driven by the selecting circuits 12SA and 12SB. Thus, as an example, a description is made below of the configuration in which the gate lines L1GA and L1GB are driven by the selecting circuits. 11GA and 11GB.

Reference symbols 41GA and 41GB denote a first gate driver signal of a first image signal and a terminal receiving input thereof, and a first gate driver signal of a second image signal and a terminal receiving input thereof, respectively. The first gate driver signal terminal 41GA for the first image signal represents one terminal, whereas the first gate driver signal terminal 41GB for the second image signal represents a bunch of two combined terminals.

One signal input to the first gate driver signal terminal 41GB for the second image signal is input to the selecting circuit 11GA, and another signal input to the first gate driver signal terminal 41GB is input to the selecting circuit 11GB. Note that one signal input to the first gate driver signal terminal 41GA for the first image signal is input to the selecting circuits 11GA and 11GB in common.

Reference symbol 31G denotes a mode control terminal which receives input of a signal for switching, through the mode switching circuit 1G, between a mode in which the gate lines L1GA and L1GB are collectively driven (hereinafter, abbreviated as collective mode) and a mode in which the gate lines L1GA and L1GB are independently driven (hereinafter, abbreviated as independent mode).

In a case where the “0” signal is input to the mode control terminal 31G, the mode switching circuit 1G goes into the collective mode, and in accordance with a signal input to the first gate driver signal terminal 41GA for the first image signal, the gate lines L1GA and L1GB are driven together in response to the same signal through the selecting circuits 11GA and 11GB.

On the other hand, in a case where the “1” signal is input to the mode control terminal 31G, the mode switching circuit 1G goes into the independent mode. In response to one signal input to the first gate driver signal terminal 41GB for the second image signal, the gate line L1GA is driven through the selecting circuit 11GA, and in response to another signal input to the first gate driver signal terminal 41GB for the second image signal, the gate line L1GB is driven through the selecting circuit 11GB.

### Fourth Embodiment

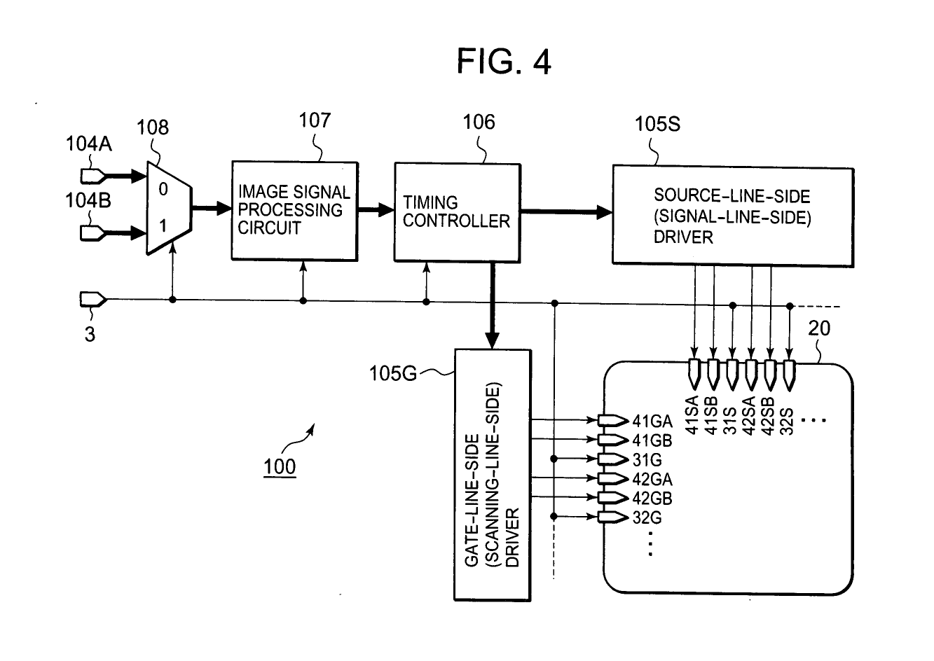

FIG. 4 is a system diagram showing a configuration of a multi-domain display device according to a fourth embodiment of the present invention. Reference numeral 100 denotes the multi-domain display device, and in particular, FIG. 4 shows a system diagram of the multi-domain display device 100 in which a monitor device is emphasized based on the fundamental block diagram shown in FIG. 3.

What is denoted by reference numeral 20 corresponds to the block diagram shown in FIG. 3, which is driven by a gate-line-side driver and a source-line-side driver denoted by reference symbols 105G and 105S, respectively. Note that the gate-line-side mode switching circuit 1G and the source-line-side mode switching circuit 1S shown in FIG. 3 may adopt a configuration in which a function of the gate-line-side mode switching driver 105G and a function of the source-line-side driver 105S are included, respectively.

Reference symbols 104A and 104B denote terminals receiving input of the first image signal and the second image signal, respectively, and the second image signal can include a higher-resolution image signal compared with the first image signal. What is denoted by reference numeral 3 corresponds to the mode control terminal shown in FIG. 1 and FIG. 2, which is connected in common to the gate-line-side mode control terminal 31G, a gate-line-side mode control terminal 32G, and source-line-side mode control terminals 31S and 32S, which are shown in FIG. 3. Therefore, the mode control terminal 3 can control switching between the collective mode and the independent mode with respect to an entire block of the multi-domain display device 20.

Reference numeral 108 denotes a selecting circuit, which propagates a signal input to the first image signal terminal 104A to the next stage in a case where the “0” signal is input to the mode control terminal 3, that is, in a case of the collective mode, and propagates a high-resolution image signal input to the second image signal terminal 104B to the next state in a case where the “1” signal is input to the mode control terminal 3, that is, in a case of the independent mode.

Reference numeral 107 denotes an image signal processing circuit processing an image signal output from the selecting circuit 108, which specifically performs image extension/reduction, image interpolation, gradation conversion, color conversion, direction conversion, or the like.

The image signal processing circuit 107 operates and controls various parameters (for example, gradation curve in the gradation interpolation) to be subjected to image processing in response to a signal input to the mode control terminal 3, that is, in a case of receiving input of a high-resolution image signal input to the second image signal terminal 104B through the selecting circuit 108.

Reference numeral 106 denotes a timing controller, which generates timing of a scanning pulse signal, at which the gate driver signal terminals 41GA and 41GB, gate driver signal terminals 42GA and 42GB are driven by the gate-line-side driver 105G based on image information output from the image signal processing circuit 107, and generates timing at which the source-line-side driver 105S needs to be synchronized with a voltage value of a signal and a scanning pulse signal for driving source driver signal terminals 41SA, 41SB, 42SA, and 42SB.

Further, the timing controller 106 controls and operates signals generated by the gate-line-side driver 105G and the source-line-side driver 105S in response to the signal input to the mode control signal terminal 3.

In a case where the “0” signal is input to the mode control terminal 3, the multi-domain display device 100 goes into the collective mode, and based on the image signal input to the first image signal terminal 104A, performs operation and control so that the gate-line-side driver 105G generates a signal for driving only the gate driver signal terminals 41GA and 42GA, and performs operation and control so that the source-line-side driver 105S generates a signal for driving only the source driver signal terminals 41SA and 42SA.

On the other hand, in a case where the “1” signal is input to the mode control terminal 3, the multi-domain display device 100 goes into the independent mode, and based on the image signal input to the second image signal terminal 104B, performs operation and control so that the gate-line-side driver 105G generates a signal for driving only the gate driver signal terminals 41GB and 42GB, and performs operation and control so that the source-line-side driver 105S generates a signal for driving only the source driver signal terminals 41SB and 42SB.

### Fifth Embodiment

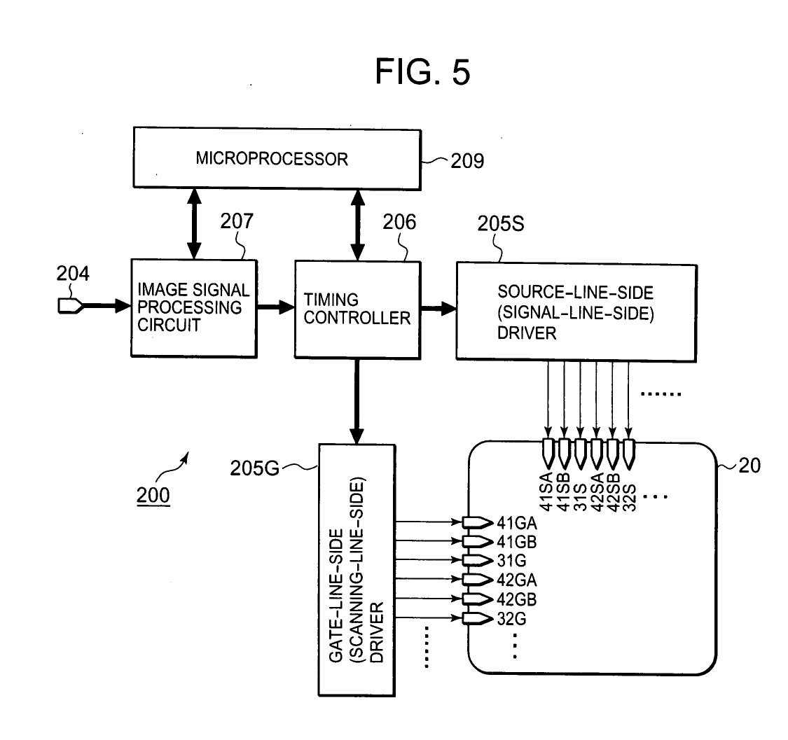

FIG. 5 is a system diagram showing another configuration of a multi-domain display device according to a fifth embodiment of the present invention. Reference numeral 200 denotes the multi-domain display device, and FIG. 5 shows a system diagram of the multi-domain display device in which a monitor device is emphasized, which is particularly based on the fundamental block diagram shown in FIG. 3.

What is denoted by reference numeral 20 corresponds to the block diagram shown in FIG. 3, which is driven by a gate-line-side driver and a source-line-side driver denoted by reference numerals 205G and 205S, respectively. Reference numeral 204 denotes a terminal receiving input of an image signal, which can receive a high-resolution image signal. Reference numeral 207 denotes an image signal processing circuit for processing an image signal output from the selecting circuit 108, and a basic function thereof is the same as that of the image processing circuit shown in FIG. 4.

Reference numeral 206 denotes a timing controller, and a basic function thereof is the same as that of the timing controller 106 shown in FIG. 4, but based on the image information output from the image signal processing circuit 207, the timing controller 206 further generates a signal for driving the gate-line-side mode control terminals 31G and 32G by the gate-line-side driver 205G, and a signal for driving the source-line-side mode control terminals 31S and 32S by the source-line-side driver 205S. In other words, the gate lines L1GA, L1GB, L2GA, and L2GB configuring the multi-domain display device 20 can be operated and controlled individually, and the source lines L1SA, L1SB, L2SA, and L2SB can be operated and controlled individually.

Reference numeral 209 denotes a microprocessor, which operates and controls functional operation of the image signal processing circuit 207 and the timing controller 206 in response to the image signal input to the image signal terminal 204, or in response to an instruction issued by a viewer of an image. In particular, by the gate-line-side mode switching circuit 1G and the source-line-side mode switching circuit 1S configuring the multi-domain display device 20, the gate-line-side mode control terminals 31G and 32G, and the source-line-side mode control terminals 31S and 32S are operated and controlled individually in individual units so as to switch between the collective mode and the independent mode in individual units of the pixels 211, 212, 221, and 222.

For example, the microprocessor 209 analyzes an image signal input to the image signal terminal 204, and determines whether the input image signal is a character image requiring a high resolution or a natural landscape image requiring a high viewing-angle, to thereby instruct selection between the independent mode and the collective mode to the image signal processing circuit 207 and the timing controller 206 based on the determination result.

The function described above is called consumer electric control (CEC) as a general term. A software program which works together with the microprocessor 209 in order to cause the microprocessor 209, that is, hardware to perform the function described above is called a CEC program. In this case, the microprocessor is taken as an example of general CEC hardware. However, the present invention is not limited thereto, and a circuit of an application specific standard product (ASSP) used in a CEC field may be applied.

Next, timing charts showing operation of the multi-domain display device 20 are illustrated. Characteristics of the respective timing charts are first summarized, and then details of the respective timing charts are described sequentially.

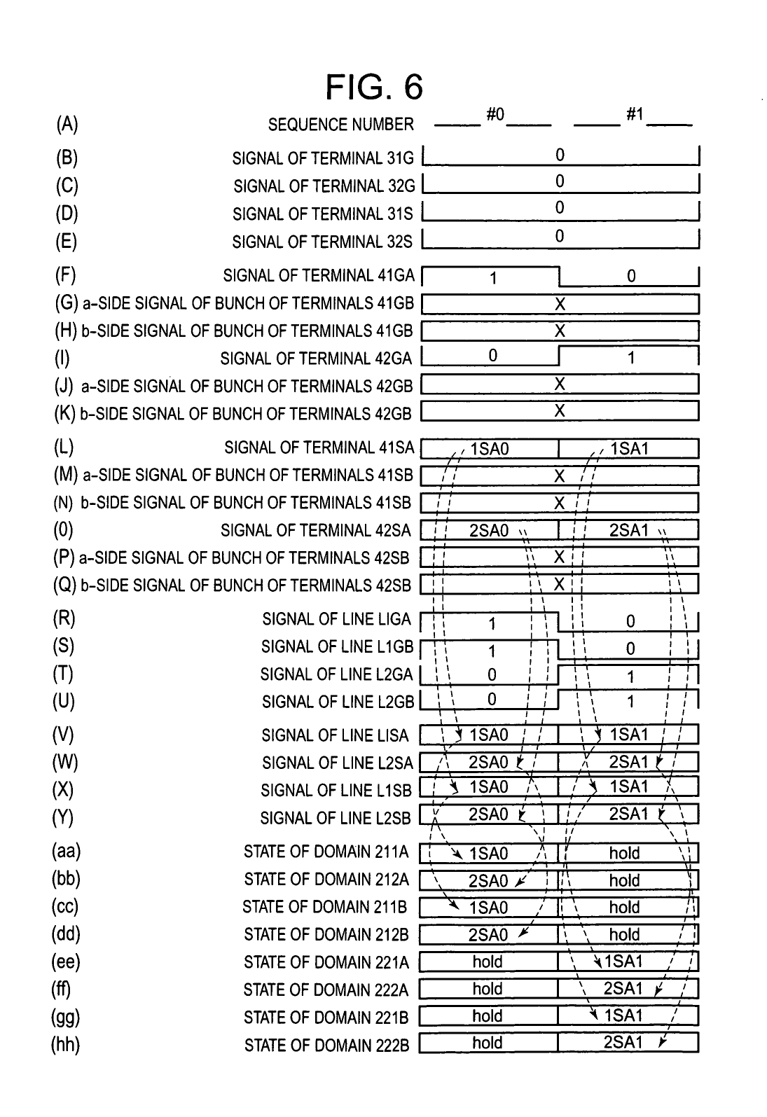

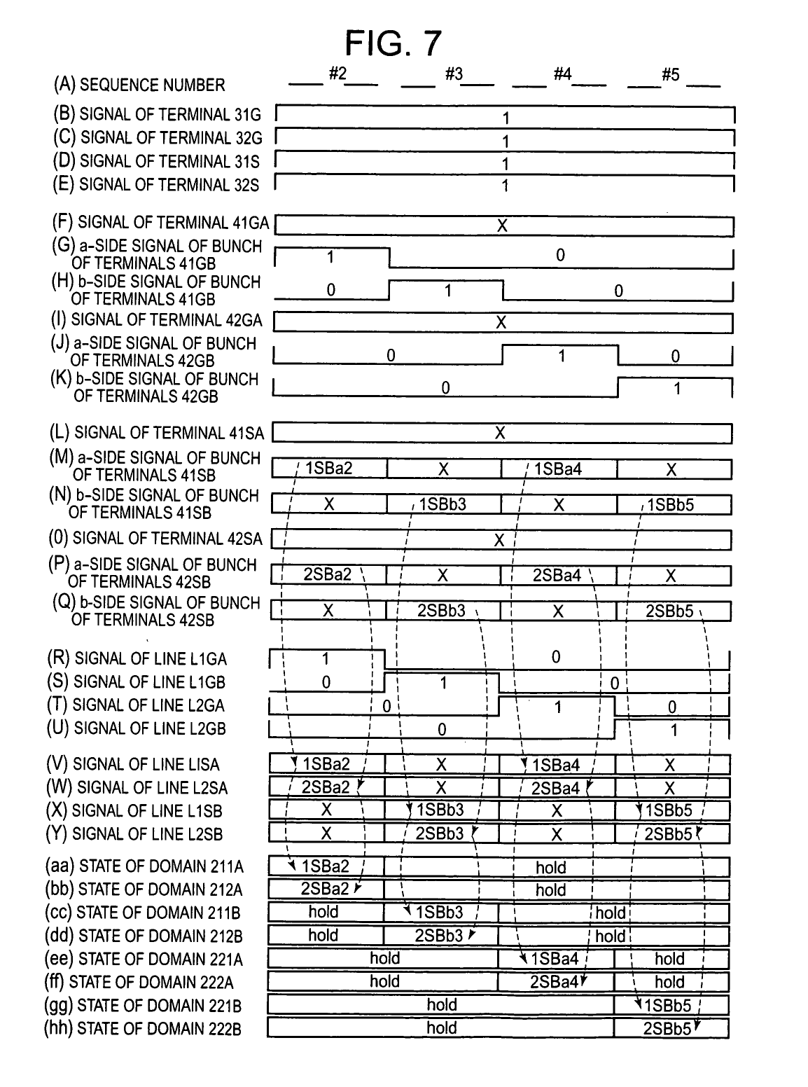

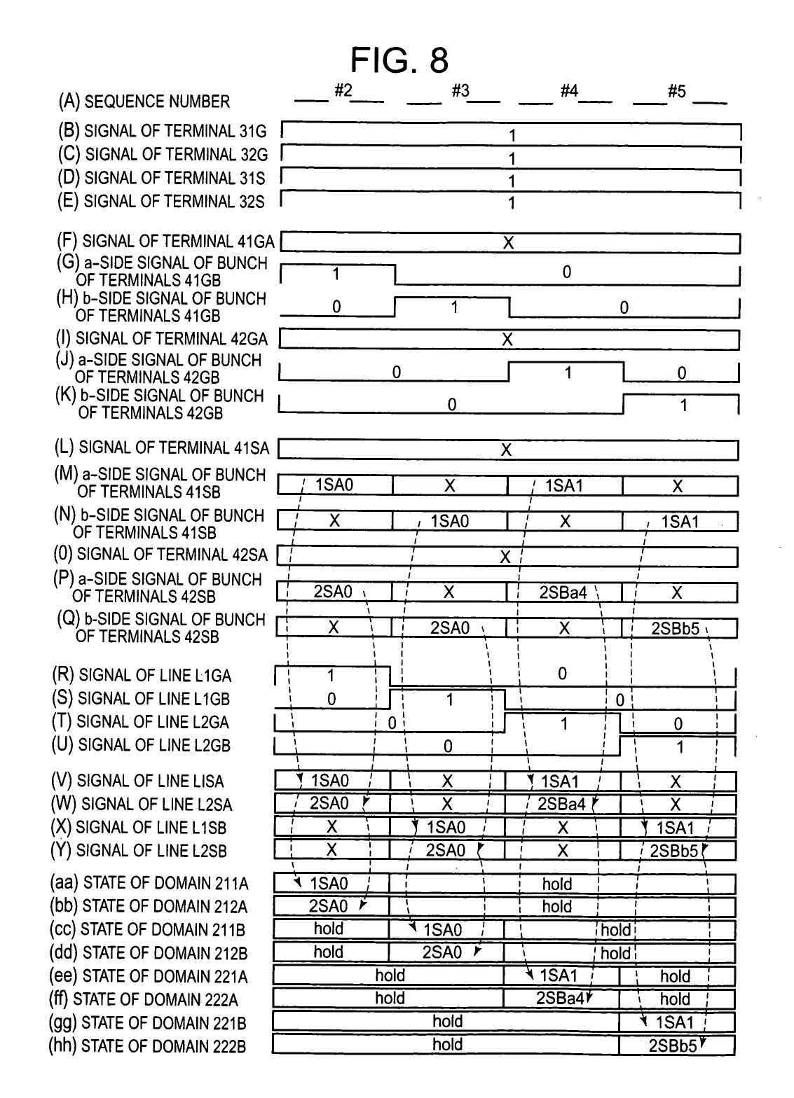

FIG. 6 is a timing chart in a case where the multi-domain display device 20 is in the collective mode. FIG. 7 and FIG. 8 each are timing charts in the case where the multi-domain display device 20 is in the independent mode. In particular, FIG. 8 is a timing chart in a case where the multi-domain display device 20 is operated and controlled so as to be seemingly in the collective mode (except the pixel 222) while actually being in the independent mode.

### (Timing Chart of FIG. 6)

First, in a detailed description of the timing chart of FIG. 6, FIG. 6A shows numbers partitioning this timing chart, and shows that an event proceeds for each number. A signal of the first gate-line-side mode control terminal 31G shown in FIG. 6B, a signal of the second gate-line-side mode control terminal 32G shown in FIG. 6C, a signal of the first source-line-side mode control terminal 31S shown in FIG. 6D, and a signal of the second source-line-side mode control terminal 32S shown in FIG. 6E are each fixed to the “0” signal, that is, fixed to the collective mode.

Accordingly, only a signal input to the first gate driver signal terminal 41GA for the first image signal shown in FIG. 6F, a signal input to the second gate driver signal terminal 42GA for the first image signal shown in FIG. 6I, a signal input to the first source driver signal terminal 41SA for the first image signal shown in FIG. 6L, and a signal input to the second source driver signal terminal 42SA for the first image signal shown in FIG. 6O are validated.

Next, with a sequence number #0, the “1” signal is input to the first gate driver signal terminal 41GA for the first image signal, and the “0” signal is input to the second gate driver signal terminal 42GA for the first image signal, and then the “1” signal appears on the gate line L1GA shown in FIG. 6R and the gate line L1GB shown in FIG. 6S, and the “0” signal appears on the gate line L2GA shown in FIG. 6T and the gate line L2GB shown in FIG. 6U. Accordingly, the thin film transistors T11A, T11B, T12A, and T12B become the ON state, while the thin film transistors T21A, T21B, T22A, and T22B become the OFF state.

On the other hand, when an image signal value “1SA0” is input to the first source driver signal terminal 41SA for the first image signal, and an image signal value “2SA0” is input to the second source driver signal terminal 42SA for the first image signal, a “1SA0” signal appears on the source line L1SA shown in FIG. 6V and the source line L1SB shown in FIG. 6X, and a “2SA0” signal appears on the source line L2SA shown in FIG. 6W and the source line L2SB shown in FIG. 6Y. As a result, the domain 211A shown in FIG. 6aa and the domain 211B shown in FIG. 6cc become, through the thin film transistors T11A and T11B in the ON state, respectively, a state of a signal value “1SA0”, and the domain 212A shown in FIG. 6bb and the domain 212B shown in FIG. 6dd become, through the thin film transistors T12A and T12B in the ON state, respectively, a state of a signal value “2SA0”.

Note that, the thin film transistors T21A, T21B, T22A, and T22B are in the OFF state with the sequence number #0, and hence the states of the domains 221A, 221B, 222A, and 222B are maintained based on the potentials charged in the auxiliary capacitors C21A, C21B, C22A, and C22B, respectively. Accordingly, the states “hold” of the domains 221A, 221B, 222A, and 222B shown in FIG. 6ee, FIG. 6gg, FIG. 6ff, and FIG. 6hh, respectively, mean that the immediately preceding states are maintained.

Next, with a sequence number #1, the “0” signal is input to the first gate driver signal terminal 41GA of the first image signal, and the “1” signal (which is in a state completely opposite to a case of the sequence number #0) is input to the second gate driver signal terminal 42GA for the first image signal, and then the “0” signal appears on the gate line L1GA shown in FIG. 6R and the gate line L1GB shown in FIG. 6S, and the “1” signal appears on the gate line L2GA shown in FIG. 6T and the gate line L2GB shown in FIG. 6U. Accordingly, the thin film transistors T11A, T11B, T12A, and T12B become the OFF state, while the thin film transistors T21A, T21B, T22A, and T22B become the ON state (which is a state completely opposite to the case of the sequence number #0).

Next, when an image signal value “1SA1” is input to the first source driver signal terminal 41SA for the first image signal, and an image signal value “2SA1” is input to the second source driver signal terminal 42SA for the first image signal, a “1SA1” signal appears on the source line L1SA shown in FIG. 6V and the source line L1SB shown in FIG. 6X, and a “2SA1” signal appears on the source line L2SA shown in FIG. 6W and the source line L2SB shown in FIG. 6Y. As a result, the domain 221A shown in FIG. 6ee and the domain 221B shown in FIG. 6gg become, through the thin film transistors T21A and T21B in the ON state, respectively, a state of a signal value “1SA1”, and the domain 222A shown in FIG. 6ff and the domain 222B shown in FIG. 6hh become, through the thin film transistors T22A and T22B in the ON state, respectively, a state of a signal value “2SA1”.

On the other hand, the thin film transistors T11A, T11B, T12A, and T12B are in the OFF state with the sequence number #1, and hence the states of the domains 211A, 211B, 212A, and 212B are maintained based on the potentials charged in the auxiliary capacitors C11A, C11B, C12A, and C12B, respectively. Accordingly, the states “hold” of the domains 211A, 211B, 212A, and 212B shown in FIG. 6aa, FIG. 6cc, FIG. 6bb, and FIG. 6dd, respectively, mean that the immediately preceding states are maintained, that is, that the domains 211A and 211B are maintained in the state of the signal value “1SA0”, and the domains 212A and 212B are maintained in the state of the signal value “2SA0”.

The two domains each configuring the pixels 211, 212, 221, and 222 with a final sequence number #1 of FIG. 6 are maintained in the sate of the same signal value, which enables image display with a high viewing-angle.

### (Timing Chart of FIG. 7)

First, in a detailed description of the timing chart of FIG. 7, FIG. 7A shows a number partitioning this timing chart, and shows that an event proceeds for each number. A signal of the first gate-line-side mode control terminal 31G shown in FIG. 7B, a signal of the second gate-line-side mode control terminal 32G shown in FIG. 7C, a signal of the first source-line-side mode control terminal 31S shown in FIG. 7D, and a signal of the second source-line-side mode control terminal 32S shown in FIG. 7E are each fixed to the “1” signal, that is, fixed to the independent mode.

Accordingly, only one (a-side) signal input to the bunch of the first gate driver signal terminals 41GB for the second image signal shown in FIG. 7G, another (b-side) signal input to the bunch of the first gate driver signal terminals 41GB for the second image signal shown in FIG. 7H, one (a-side) signal input to the bunch of the second gate driver signal terminals 42GB for the second image signal shown in FIG. 7J, and another (b-side) signal input to the bunch of the second gate driver signal terminals 42GB for the second image signal shown in FIG. 7K are validated.

Accordingly, only one (a-side) signal input to the bunch of the first source driver signal terminals 41SB for the second image signal shown in FIG. 7M, another (b-side) signal input to the bunch of the first source driver signal terminals 41SB for the second image signal shown in FIG. 7N, one (a-side) signal input to the bunch of the second source driver signal terminals 42SB for the second image signal shown in FIG. 7P, and another (b-side) signal input to the bunch of the second source driver signal terminals 42SB for the second image signal shown in FIG. 7Q are validated.

With a sequence number #2, the “1” signal is input to the one (a-side) bunch of the first gate driver signal terminals 41GB for the second image signal, and the “0” signal is input to the another (b-side) bunch of the first gate driver signal terminals 41GB for the second image signal, and the one (a-side) bunch of the second gate driver signal terminals 42GB and another (b-side) bunch of the second gate driver signal terminals 42GB for the second image signal, and then the “1” signal appears on the gate line L1GA shown in FIG. 7R, the “0” signal appears on the gate line L1GB shown in FIG. 7S, the gate line L2GA shown in FIG. 7T, and the gate line L2GB shown in FIG. 7U. Accordingly, the thin film transistors T11A and T12A become the ON state, and the thin film transistors T11B, T12B, T21A, T21B, T22A, and T22B become the OFF state.

On the other hand, an image signal value “1SBa2” is input to the one (a-side) bunch of the first source driver signal terminals 41SB for the second image signal, and an image signal value “2SBa2” is input to the one (a-side) bunch of the second source driver signal terminals 42SB for the second image signal, and then a “1SBa2” signal appears on the source line L1SA shown in FIG. 7V, and a “2SBa2” signal appears on the source line L2SA shown in FIG. 7W. Accordingly, the domain 211A shown in FIG. 7aa becomes, through the thin film transistor T11A in the ON state, a state of the signal value “1SBa2”, and the domain 212A shown in FIG. 7bb becomes, through the thin film transistor T12A in the ON state, a sate of the signal value “2SBa2”.

Note that, with a sequence number #2, the thin film transistors T11B, T12B, T21A, T21B, T22A, and T22B are in the OFF state, and thus the states of the domains 211B, 212B, 221A, 221B, 222A, and 222B are maintained based on the existing potentials charged in the auxiliary capacitors C11B, C12B, C21A, C21B, C22A, and C22B, respectively. Accordingly, the states “hold” of the domains 211B, 212B, 221A, 222A, 221B, and 222B which are shown in FIG. 7cc, FIG. 7dd, FIG. 7ee, FIG. 7ff, FIG. 7gg, and FIG. 7hh, respectively, mean that the immediately preceding states are maintained.

With a sequence number #3, the “1” signal is input to the another (b-side) bunch of the first gate driver signal terminals 41GB for the second image signal, and the “0” signal is input to the one (a-side) bunch of the first gate driver signal terminals 41GB of the second image signal, and the one (a-side) bunch of the second gate driver signal terminals 42GB and another (b-side) bunch of the second gate driver signal terminals 42GB for the second image signal, and then the “1” signal appears on the gate line L1GB shown in FIG. 7S, the “0” signal appears on the gate line L1GA shown in FIG. 7R, the gate line L2GA shown in FIG. 7T, and the gate line L2GB shown in FIG. 7U. Accordingly, the thin film transistors T11B and T12B become the ON state, and the thin film transistors T11A, T12A, T21A, T21B, T22A, and T22B become the OFF state.

On the other hand, an image signal value “1SBa3” is input to the another (b-side) bunch of the first source driver signal terminals 41SB for the second image signal, and an image signal value “2SBa3” is input to the another (b-side) bunch of the second source driver signal terminals 42SB for the second image signal, and then a “1SBa3” signal appears on the source line L1SB shown in FIG. 7X, and a “2SBa3” signal appears on the source line L2SB shown in FIG. 7Y. Accordingly, the domain 211B shown in FIG. 7cc becomes, through the thin film transistor T11B in the ON state, a state of the signal value “1SBa3”, and the domain 212B shown in FIG. 7dd becomes, through the thin film transistor T12B in the ON state, a sate of the signal value “2SBa3”.

Note that, with a sequence number #3, the thin film transistors T11A, T12A, T21A, T21B, T22A, and T22B are in the OFF state, and thus the states of the domains 211A, 212A, 221A, 221B, 222A, and 222B are maintained based on the existing potentials charged in the auxiliary capacitors C11A, C12A, C21A, C21B, C22A, and C22B, respectively. Accordingly, the states “hold” of the domains 211A, 212A, 221A, 222A, 221B, and 222B which are shown in FIG. 7aa, FIG. 7bb, FIG. 7ee, FIG. 7ff, FIG. 7gg, and FIG. 7hh, respectively, mean that the immediately preceding states are maintained. This means that the domain 211A is maintained in the state of the signal value “1SBa2”, and that the domain 212A is maintained in the state of the signal value “2SBa2”.

With a sequence number #4, the “1” signal is input to the one (a-side) bunch of the second gate driver signal terminals 42GB for the second image signal, and the “0” signal is input to the one (a-side) bunch of the first gate driver signal terminals 41GB for the second image signal, and the another (b-side) bunch of the second gate driver signal terminals 42GB and another (b-side) bunch of the second gate driver signal terminals 42GB for the second image signal, and then the “1” signal appears on the gate line L2GA shown in FIG. 7T, the “0” signal appears on the gate line L1GA shown in FIG. 7R, the gate line L1GB shown in FIG. 7S, and the gate line L2GB shown in FIG. 7U. Accordingly, the thin film transistors T21A and T22A become the ON state, and the thin film transistors T11A, T12B, T12A, T12B, T21B, and T22B become the OFF state.

On the other hand, an image signal value “1SBa4” is input to the one (a-side) bunch of the first source driver signal terminals 41SB for the second image signal, and an image signal value “2SBa4” is input to the one (a-side) bunch of the second source driver signal terminals 42SB for the second image signal, and then a “1SBa4” signal appears on the source line L1SA shown in FIG. 7V, and a “2SBa4” signal appears on the source line L2SA shown in FIG. 7W. Accordingly, the domain 221A shown in FIG. 7ee becomes, through the thin film transistor T21A in the ON state, a state of the signal value “1SBa4”, and the domain 222A shown in FIG. 7ff becomes, through the thin film transistor T22A in the ON state, a sate of the signal value “2SBa4”.

Note that, with a sequence number #4, the thin film transistors T11A, T11B, T12A, T12B, T21B, and T22B are in the OFF state, and thus the states of the domains 211A, 211B, 212A, 212B, 221B, and 222B are maintained based on the existing potentials charged in the auxiliary capacitors C11A, C11B, C12A, C12B, C21B, and C22B, respectively. Accordingly, the states “hold” of the domains 211A, 212A, 211B, 212B, 221B, and 222B which are shown in FIG. 7aa, FIG. 7bb, FIG. 7cc, FIG. 7dd, FIG. 7gg, and FIG. 7hh, respectively, mean that the immediately preceding states are maintained. This means that the domain 211B is maintained in the state of the signal value “1SBa3”, and that the domain 212B is maintained in the state of the signal value “2SBa3”.

Next, with a sequence number #5, the “1” signal is input to the another (b-side) bunch of the second gate driver signal terminals 42GB for the second image signal, and the “0” signal is input to the one (a-side) bunch of the first gate driver signal terminals 41GB for the second image signal and the another (b-side) bunch of the first gate driver signal terminals 41GB for the second image signal, and the one (a-side) bunch of the second gate driver signal terminals 42GB for the second image signal. As a result, the “1” signal appears on the gate line L2GB shown in FIG. 7U, and the “0” signal appears on the gate line L1GB shown in FIG. 7S, and the gate line L2GA shown in FIG. 7T. Accordingly, the thin film transistors T21B and T22B become the ON state, and the thin film transistors T11A, T11B, T12A, T12B, T21A, and T22A become the OFF state.

On the other hand, an image signal value “1SBb5” is input to the another (b-side) bunch of the first source driver signal terminals 41SB for the second image signal, and an image signal value “2SBb5” is input to the another (b-side) bunch of the second source driver signal terminals 42SB of the second image signal, and then a “1SBb5” signal appears on the source line L1SB shown in FIG. 7X, and a “2SBb5” signal appears on the source line L2SB shown in FIG. 7Y. Accordingly, the domain 221B shown in FIG. 7gg becomes, through the thin film transistor T11A in the ON state, a state of the signal value “1SBb5”, and the domain 222B shown in FIG. 7hh becomes, through the thin film transistor T22B in the ON state, a sate of the signal value “2SBb5”.

Note that, with a sequence number #5, the thin film transistors T11A, T11B, T12A, T12B, T21A, and T22A are in the OFF state, and thus the states of the domains 211A, 211B, 212A, 212B, 221A, and 222A are maintained based on the existing potentials charged in the auxiliary capacitors C11A, C11B, C12A, C12B, C21A, and C22A, respectively. Accordingly, the states “hold” of the domains 211A, 212A, 211B, 212B, 221A, and 222A which are shown in FIG. 7aa, FIG. 7bb, FIG. 7cc, FIG. 7dd, FIG. 7ee, and FIG. 7ff, respectively, mean that the immediately preceding states are maintained. This means that the domain 221A is maintained in the state of the signal value “1SBa4”, and that the domain 222A is maintained in the state of the signal value “2SBa4”.

With a final sequence number #5 of FIG. 7, the two domains each configuring the pixels 211, 212, 221, and 222 are maintained in the states of the different signal values, which enables image display having a high resolution.

### (Timing Chart of FIG. 8)

First, in a detailed description of the timing chart of FIG. 8, FIG. 8A shows numbers partitioning this timing chart, and shows that an event proceeds for each number. The same initial value and final value of the sequence number are used in FIG. 7 and FIG. 8.

A signal of the first gate-line-side mode control terminal 31G shown in FIG. 8B, a signal of the second gate-line-side mode control terminal 32G shown in FIG. 8C, a signal of the first source-line-side mode control terminal 31S shown in FIG. 8D, and a signal of the second source-line-side mode control terminal 32S shown in FIG. 8E are each fixed to the “1” signal, that is, fixed to the independent mode, which is the same as in the case of the timing chart shown in FIG. 7.

Further, timing charts shown in FIG. 8G, FIG. 8H, FIG. 8J, and FIG. 8K are the same as those shown in FIG. 7G, FIG. 7H, FIG. 7J, and FIG. 7K, and hence the gate lines L1GA, L1GB, L2GA, and L2GB are subjected to line-by-line scanning for activation performed in the stated order.

As for input of the signal, FIG. 8 is particularly different from FIG. 7 in signals input to the first and second source driver signal terminal for the second image signal, which are shown in FIG. 8M, FIG. 8N, FIG. 8P, and FIG. 8Q. That is, in FIG. 8 in contrast to FIG. 7, the signal value “1SBa2” is replaced by a signal value “1SA0” in the sequence number #2. Similarly, the signal value “2SBa2” is replaced by a signal value “2SA0” in the sequence number #2, the signal value “1SBb3” is replaced by a signal value “1SA0” in the sequence number #3, the signal value “2SBb3” is replaced by a signal value “2SA0” in the sequence number #3, the signal value “1SBa4” is replaced by a signal value “1SA1” in the sequence number #4, and the signal value “1SBb5” is replaced by a signal value “1SA1” in the sequence number #5.

Note that the signal value “2SBa4” of the sequence number #4 shown in FIG. 8P and the signal value “2SBb5” of the sequence number #5 shown in FIG. 8Q are the same as those of FIG. 7.

With the final sequence number #5 of FIG. 8, the respective domains are in the states described below. The both domains 211A and 211B are in the state of the signal value “1SA0”, the both domains 212A and 212B are in the state of the signal value “2SA0”, and the both domains 221A and 221B are in the state of the signal value “1SA1”. Only the states of the domains 222A and 222B are different from each other, and the domain 222A and the domain 222B are in the state of the signal value “2SBa4” and the state of the signal value “2SBb5”, respectively.

The states of the respective domains with the final sequence number #5 of FIG. 8 are completely the same as the states of the domains with the final sequence number #1 of FIG. 6 except for the states of the domains 222A and 222B. That is, the two domains each configuring the three pixels 211, 212, and 221 are maintained in the states of the same signal values, which enables image display having a high viewing-angle. Only the two domains configuring the pixel 222 are maintained in the states of the different signal values, which enables image display having a high resolution.

In this manner, through the operation and control as shown in the timing chart of FIG. 8, a plurality of particular pixels or sub-pixels can be switched to the mode of a high-resolution image display in the multi-domain display device in which pixels or sub-pixels are arranged in matrix. In other words, the plurality of particular pixels or sub-pixels can be switched to the mode of a high-viewing-angle image display in the multi-domain display device in which pixels or sub-pixels are arranged in matrix.

Note that the present invention is not limited to the embodiments described above, and it is needless to say that variations that do not depart from the gist of the present invention are intended to be made.

What is claimed is:

1. A device in a liquid crystal display, comprising:
a pixel divided into at least two sub-pixels, the at least two sub-pixels having characteristics of color channels different from each other, each of the at least two sub-pixels being divided into at least two domains, the at least two domains having characteristics of viewing-angles different from each other;
a first terminal coupled to one of the at least two domains to display image; and
a second terminal coupled to another of the at least two domains to display image.

2. A device in a liquid crystal display, comprising:
a pixel divided into at least two domains, the at least two domains having characteristics of viewing-angles different from each other;
a first terminal coupled to one of the at least two domains to display image; and
a second terminal coupled to another of the at least two domains to display image.

3. A device in a liquid crystal display, comprising:
a pixel divided into at least two sub-pixels, the at least two sub-pixels having characteristics of color channels different from each other, each of the at least two sub-pixels being divided into at least two domains, the at least two domains having characteristics of viewing-angles different from each other;
a mode control terminal receiving a mode control signal; and
a mode switching circuit coupled to the mode control terminal to switch between two modes in response to the mode control signal, the mode switching circuit being operable to commonly display image on the at least two domains with respect to one of the two modes, the mode switching circuit being operable to individually display image on the at least two domains with respect to another of the two modes.

4. The device according to claim 3,
wherein the mode switching circuit commonly drives the at least two domains in response to a first image signal during the one of the two modes, drives one of the at least two domains in response to a second image signal during the another of the two modes and drives another of the at least two domains in response to a third image signal during the another of the two modes.

5. The device according to claim 3,
wherein the mode switching circuit commonly drives the at least two domains in response to a first image signal during the one of the two modes, drives one of the at least two domains in response to the first image signal during the another of the two modes and drives another of the at least two domains in response to a second image signal during the another of the two modes.

6. A device in a liquid crystal display, comprising:
a pixel divided into at least two domains, the at least two domains having characteristics of viewing-angles different from each other;
a mode control terminal receiving a mode control signal; and
a mode switching circuit coupled to the mode control terminal to switch between two modes in response to the mode control signal, the mode switching circuit being operable to commonly display image on the at least two domains with respect to one of the two modes, the mode switching circuit being operable to individually display image on the at least two domains with respect to another of the two modes.

7. The device according to claim 6,
wherein the mode switching circuit commonly drives the at least two domains in response to a first image signal during the one of the two modes, drives one of the at least two domains in response to a second image signal during the another one of the two modes and drives another of the at least two domains in response to a third image signal during the another one of the two modes.

8. The device according to claim 6,
wherein the mode switching circuit commonly drives the at least two domains in response to a first image signal during the one of the two modes, drives one of the at least two domains in response to the first image signal during the another of the two modes and drives another one of the at least two domains in response to a second image signal during the another of the two modes.
